(19) United States
(12) Patent Application Publication
(10) Pub. No.: US 2007/0011301 A1
(43) Pub. Date: Jan. 11, 2007

(54) Provisioning relay and re-direction server for service implementation on generic customer premises equipment

(76) Inventors: Pin Pin Ong, San Ramon, CA (US); Manrique Brenes, Corona Del Mar, CA (US); Yutai T. Koh, San Diego, CA (US)

Correspondence Address: MACPHERSON KWOK CHEN & HEID LLP, 2033 GATEWAY PLACE, SUITE 400, SAN JOSE, CA, 95110, US

(21) Appl. No.: 11/178,971

(22) Filed: Jul. 11, 2005

(51) Int. Cl. G06F 15/173

(52) U.S. Cl. 709/224

(57) ABSTRACT

In accordance with an embodiment of the present invention, a customer premises equipment (CPE) includes a memory unit, a communications unit, and a processing unit. The memory unit stores and retrieves a plurality of network addresses, including a default server network address corresponding to a default server. The communications unit can send messages to and receive messages from a plurality of servers over a communications network. Each server is specified by a unique network address. The processing unit determines if a configuration server network address is present within the memory unit. If the configuration server network address is not present within the CPE the processing unit retrieves the default server network address from the memory unit and sends a configuration server network address request message through the communications unit to the default server requesting the configuration server network address.

### TECHNICAL FIELD

This invention relates generally to electronic communication over a network, and more particularly to establishing service for a subscriber having a generic customer premises equipment (CPE) device or apparatus where access information for a configuration server is not initially contained within the CPE.

### BACKGROUND

Subscriber provisioning involves the allocation of network resources and the configuration of network equipment to establish services for the first time. When configuration information is not initially contained within a customer premises equipment (CPE) apparatus, the information may be loaded into the CPE apparatus during manufacture so that once the CPE apparatus is connected to the network the CPE will retrieve this stored information and access a configuration server. Alternatively, a user may enter the access information manually, or by accessing a service provider web-portal.

From a business perspective, those customers who require a large number of CPE devices configured to setup service from a particular service provider can justify the increased cost in order to request the CPE devices be configured at the factory to include information used for configuring with a particular service provider. At the other end of the continuum, for those customer who require a relatively small number of CPE devices configured to setup service can individually configure their CPE devices since the scale of the configuration operation is small enough to justify spending the resources, including time and manpower, in order to configure a small number of CPE devices. However, the intermediate scale deployment of generic CPE can be problematic. Accordingly, there is a need in the art for a configuring apparatus and method for use with intermediate sized deployment where for each CPE device the service provider information is not initially specified.

### BRIEF DESCRIPTION OF THE DRAWINGS

FIG. 1 shows a simplified view of a Voice Over Internet Protocol (VoIP) system, in accordance with an embodiment of the invention.

FIG. 2 shows a block diagram of a customer premises equipment (CPE) apparatus, in accordance with an embodiment of the invention.

FIG. 3 shows a flow diagram describing a series of operations comprising a provisioning flow where the service provider (SP) address not initially present within the CPE at the start of provisioning, in accordance with an embodiment of the invention.

FIG. 4 shows a flow diagram describing a series of operations comprising a provisioning flow.

FIG. 5 shows a flow diagram describing a series of operations comprising a provisioning flow, in accordance with an embodiment of the invention.

FIG. 6 shows an exemplary transaction diagram for a portion of the procedure to establishing a transport layer security (TLS) connection between a CPE and a default server, in accordance with an embodiment of the invention.

FIG. 7 shows a high-level flow diagram describing exemplary interactions between a CPE and a configuration server, in accordance with an embodiment of the invention.

FIG. 8 shows an exemplary service request message from a CPE, in accordance with an embodiment of the invention.

FIG. 9 shows an exemplary service response message to a CPE, in accordance with an embodiment of the invention.

FIG. 10 shows a block diagram illustrating a configuration message flow between a CPE, a default server, and a configuration server, in accordance with an embodiment of the invention.

Embodiments of the present invention and their advantages are best understood by referring to the detailed description that follows. It should be appreciated that like reference numerals are used to identify like elements illustrated in the figures.

### DETAILED DESCRIPTION

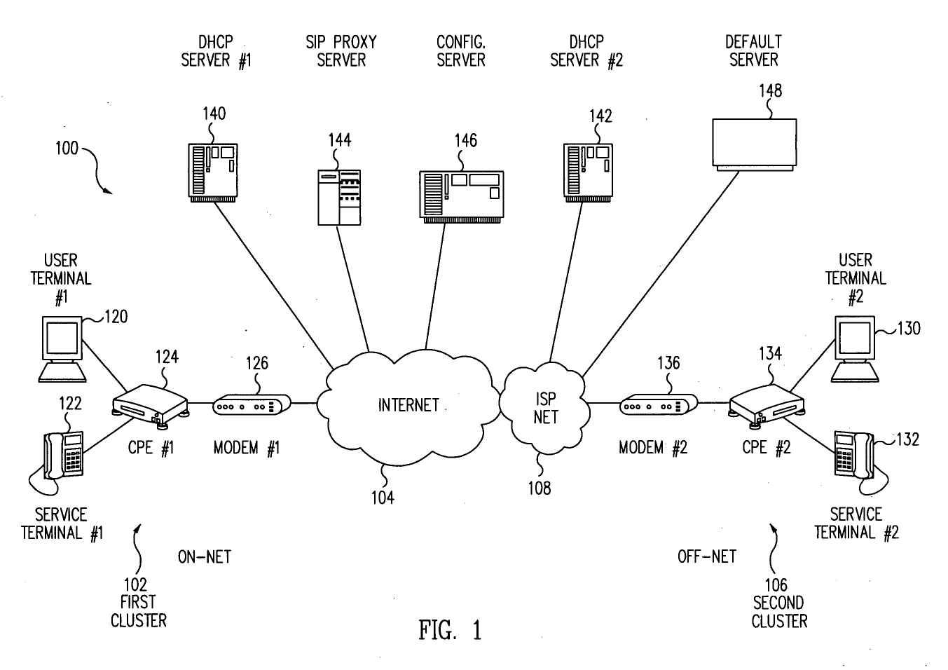

In reference to FIG. 1, a simplified view of a Voice Over Internet Protocol (VOIP) system 100 includes a first user cluster 102 connected to the Internet 104 and a second user cluster 106 connected through an Internet Service Provider (ISP) 108 to Internet 104. Although not limited to this case, the present discussion includes messages exchanged between devices connected to a switched-packet network such as the Internet 104.

First cluster 102 includes a first user terminal 120, a first service terminal 122, a first customer premises equipment (CPE) 124, and a first modem 126. First user terminal 120 can be a personal computer running a web-browser application, for example, in order to permit access for a user to the Internet 104. First service terminal 122 can be either an ordinary telephone conforming to use with the plain old telephone service (POTS) having the traditional analog inputs and outputs, or service terminal 122 can be an internet-ready telephone where information is sent and received by service terminal 122 as packets to and from the network, as described above in reference to the Internet 104.

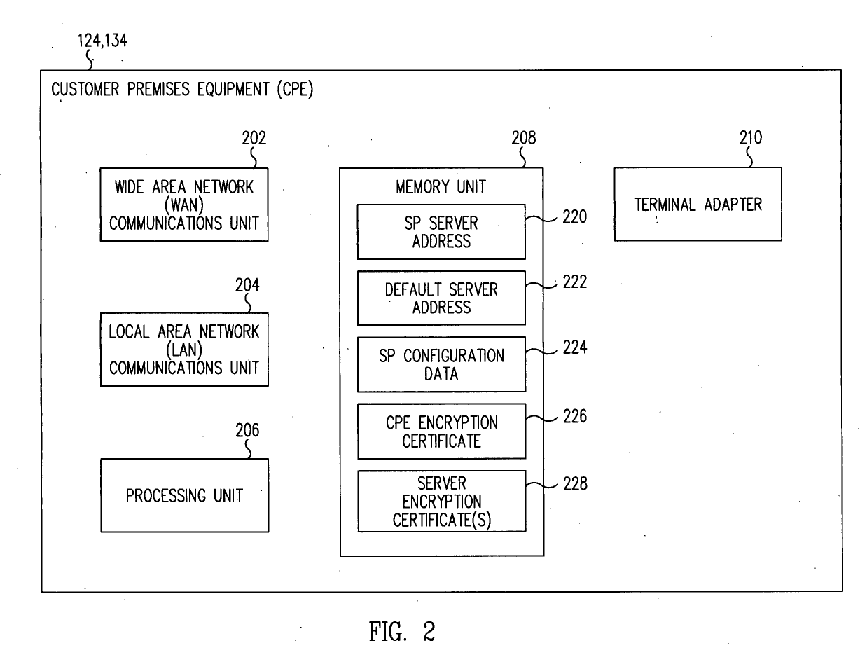

When service terminal 122 is an ordinary POTS telephone device, a terminal adapter (as shown in FIG. 2) must be used to convert the traditional analog signal information into packets. Although first service terminal 122 is shown as a telephone for use with a voice service, other types of terminals and services may be used including multimedia distribution, interactive video, or data subscription services such as news, weather, and sports. These examples are for illustration purposes only, and the actual devices and service types are not limited to only these examples.

First cluster 102 directly connects to the Internet 104 through a communications channel such as twisted-pair phone lines, a coaxial cable, or an optical link. Modem 126 provides the signaling necessary for first cluster 102 to connect to and communicate with a corresponding modem (not shown) typically belonging to an Internet Service Provider (ISP). Modem 126, can also termed a gateway modem or gateway router, and may include a digital subscriber line (DSL) or cable modem in series with a router for direct connection to the Internet 104. It is understood that each modem connects directly to another modem which may have a subsequent connection through a router to another network to other network devices so that Internet 104 includes a plurality of hierarchical interconnection networks.

CPE 124 can be a local network router such as those manufactured by LINKSYS (R) of Irvine, Calif., USA. CPE 124 can directly connect to modem 126, usually through a digital communications channel like a fixed wire network cable or a wireless connection. The term CPE is widely used and can refer to any communications equipment present at a customer site. Although both modem 126 and router 124 are typically installed at the customer site, for the purposes of this disclosure, the term CPE will be directed toward a router 124, or similar device, that may be connected directly to a modem 126, or else connected indirectly to modem 126 through another intermediate router 124 in a hierarchical manner. CPE 124, as a router, is typically a device that forwards data packets along networks based on their network addresses, and efficiently manages the information flow to and from modem 126.

Routers are typically installed at the juncture between at least two separate networks, at a place where the networks connect, in order to allow communication, or message packet passing, between the separate networks. More than one router can be connected to modem 126 if the modem is also a gateway, incorporating both modem and router functions, but each cluster is shown with only one router for simplicity. Networks can be hierarchical where one router connects to another like branches in a tree and the terminal devices, or user terminals, can be considered as leaves on the tree.

If the scope of a particular network is relatively wide, it can be arbitrarily considered as a Wide Area Network (WAN). In contrast, the relatively narrow scope of the connectivity between first user terminal 120, first service terminal 122, and first CPE 124 can be considered as a local area network (LAN). Although shown with two network devices, the LAN of first cluster 102 may contain more terminal devices, or may include another router for connection to another network. Routers such as CPE 124 are often connected between a WAN and a LAN.

Similar to first cluster 102, second cluster 106 includes a second user terminal 130, a second service terminal 132, a second customer premises equipment (CPE) 134, and a second modem 136. Second cluster 106 directly connects to ISP 108 through a communications channel such as a twisted-pair phone lines, a coaxial cable, or an optical link. Modem 136 provides the signaling necessary for first cluster 106 to connect to and communicate with a corresponding modem (not shown) within ISP 108 which then connects hierarchically to the Internet 104. In this manner, a data connection by message passing can be formed between devices on first cluster 102 to devices on second cluster 106. Similar to first DHCP server 140, a second DHCP server 142 can be used to supply an IP address for second CPE 134 and other network devices. In this example, second DHCP server 142 is located within ISP 108. Although only two clusters (102, 106) are shown, this number is not limiting.

Message packets on a switched packet network such as the Internet 104 are sent, routed, and received based on network addresses. In order to establish communication with a device or node on the network, each device must have a unique address. A first dynamic host configuration protocol (DHCP) server 140 is shown connected to Internet 104 and simplifies network management by dynamically assigning an internet protocol (IP) address when a network device is added to the network, thus avoiding the need for a manual allocation for this task. In some systems, the IP address can be dynamically changed while the network device is connected. In contrast, a static IP address does not change. Some network devices support a mixture of both dynamic and static IP addressing.

In some applications, first DHCP server 140 can be used to assign an IP address to first CPE 124. In a hierarchical manner, first CPE 124 can assign an IP address to any network device connected on the LAN of first cluster 102. Alternatively, modem 126 may be a gateway router that includes a DHCP server, or CPE 124 may be connected to an intermediate router (not shown) that provides DHCP services. In the present configuration, first DHCP server 140 provides an IP address to first CPE 124 in first cluster 102. Internet 104 is a broad, hierarchical interconnection network embracing various technologies spanning both the analog and digital domains. A network address translator (NAT) may be used in a hierarchical router or gateway in order to re-map the local network addresses so that all the network addresses are unique in a hierarchical manner.

According to the Internet Engineering Task Force (IETF) as reflected in their publication RFC3261, a session initiation protocol (SIP) proxy server 144 is shown as connected to Internet 104 and is used to create, modify, and terminate sessions that allow participants to agree on a set of compatible media types and establish connections for Internet telephone calls, multimedia distribution, and multimedia conferences, for example. In a voice over internet protocol (VOIP) application, SIP proxy server 144 routes requests to a user's current location, authenticates and authorizes users for services, implements provider call-routing policies, and provides features to users. The SIP also provides a registration function that allows users to upload their current locations for use by proxy servers. SIP runs on top of several different transport protocols such as the internet protocol (IP).

When initiating an internet telephone call for VoIP communications, for example, first service terminal 122 can initiate a call to second service terminal 132 by first contacting proxy server 144 and requesting a latency-controlled connection for a voice session with second service terminal 132. In a traditional data transfer arrangement over Internet 104, latency is not usually an issue since the data from the source is divided into discrete packets that are sent individually and then reassembled at the destination. In this manner, once the data package is reassembled, it does not matter that packets were delayed, nor does it matter that some packets may have been received out of order, as long as the packets are reassembled into their initial order and none are missing. However, in a voice connection, undue latency can cause communication difficulties. To avoid this problem, a priority circuit having a lower latency is typically established between the two ends of the VoIP connection, that is, between CPE (124, 134). In a priority case, if a voice packet and a data packet are both received by the same router, the voice packet is given priority in order to avoid introducing latency to the voice packet delivery and reassembly.

Prior to initiating an internet telephone call using a service terminal (122, 132), the CPE must be configured for service with the respective service provider (SP) through a process called provisioning where service is established with a service provider (SP). In an example including a voice service provider (VSP), a provisioned subscriber is a voice service customer whose order for voice service has been processed, and may include the assignment of a particular CPE device and a VoIP telephone number. In other cases, the particular CPE device is not yet configured, but the VoIP telephone number is associated with user data that may be associated with particular CPE information in a configuration database.

FIG. 1 shows a configuration server 146 for use in delivering CPE configuration information to a CPE that accesses the configuration server 146 and requests such information. However, a “gap” exists in the medium-scale deployment of an un-configured CPE where the deployment is too small for the CPE manufacturer to pre-configure the CPE devices prior to sale, and the deployment is too big for a service provider to individually configure each generic CPE device prior to delivery to the customer. In a large-scale deployment, the CPE manufacturer will typically pre-configure the CPE device to include a specified network address, which may be expressed as a uniform resource locator (URL), for a configuration server so that once the configured CPE is connected to an active network, the configured CPE can retrieve the configuration server URL from a memory within the CPE device and use that retrieved network address to access configuration server 146. Once each CPE is configured, either CPE may initiate a service session by accessing proxy server 144, as described, and configuration server 146 is no longer needed unless the configuration assignment changes. The configuration may change due to many reasons including, a security update or a change to the service or service provider that requires a change to the CPE configuration information.

A default server 148 contains redirection information to establish service for a previously un-configured or generic CPE device. For example, when first CPE 124 is initially connected to an active network, CPE 124 can search a predetermined configuration server address memory location to determine if pre-configuration information is present. If pre-configuration information is not present, CPE 124 can search a predetermined default server address memory location to determine if an address is present identifying a default server which can provide the configuration server address for use in configuration. CPE 124 can use the default server address to access default sever 148 in order to give identifying information and receive corresponding configuration server information. For example, CPE 124 can retrieve the default server address and access the default server over the hierarchical network by sending one or more messages to default sever 148. These messages can include CPE 124 identifying information such as a serial number, media access control (MAC) address, manufacturer name, model number, user name, and user account information.

Default server 148 includes a database where the CPE identifying information is used to identify the network address of a configuration server which CPE 124 can access in order to obtain configuration information for use in establishing service with a service provider. Alternatively, the information database may be located at a remote location to default server 148, yet is accessible so that default server 148 provides the configuration server 146 address to CPE 124. As described, CPE 124 can be connected through the Internet 104 in order to access default server 148 in an on-net configuration flow. Similarly, second CPE 134 can be connected through ISP network 108 in order to access default server 148 in an off-net configuration flow.

FIG. 2 shows a block diagram of a customer premises equipment (CPE) apparatus (124, 134) in accordance with an embodiment of the present invention. CPE (124, 134) includes a wide area network (WAN) communications unit 202 for communications over a WAN, a local area network (LAN) communications unit 204 for communications over a LAN, a processing unit 206 for moving and manipulating data within CPE (124, 134) and for controlling the sending and receiving of messages through the WAN communications unit 202 and the LAN communications unit 204, a memory unit 208 for storing and retrieving data including network addresses, and a terminal adapter 210 for interfacing with a user terminal device.

Processing unit 206 can be a suitably programmed microprocessor or microcomputer. Memory unit 208 stores and retrieves information under the control of processing unit 206. Memory unit 208 can be any device that is enabled to store and retrieve information including information such as a service provider (SP) configuration server address 220, a default server address 222, SP configuration data 224, a CPE encryption certificate 226, and one or more server encryption certificates 228. Typically, memory unit 208 can be implemented as a random access memory (RAM), a read only memory (ROM), a magnetic recording and reproducing device, or an electrically alterable storage and retrieval device such as an electrically erasable programmable ROM (EEPROM).

SP server address 220 and default server address 222 can be stored as a uniform resource locator (URL) for use on the world wide web (WWW). In this case, the URL is broadcast to a name server (not shown) that will resolve the URL to an internet protocol (IP) address. Processing unit 206 retrieves a server address (220, 222) from memory unit 208 and passes that information to WAN communications unit 202 in order to access the selected server (146, 148). Terminal adapter 210 can be implemented as a part of CPE (124, 134) or can be a stand-alone network device having a data connection to CPE (124, 134). In one embodiment, terminal adapter 210 converts analog telephone signals to digital packets in a broadcasting mode and converts digital packets to analog telephone signals in a receiving mode in order to provide network access for an otherwise non-accessible service terminal (122, 132). Various types of terminal adapters may be used to interface with other user devices. For example, a different type of terminal adapter 210 may be used to interface with a camera, a video monitor, or a hand-held device in order to provide network connectivity to these devices. In this manner, terminal adapter 210 is the final, or terminal, element on the network.

Since protecting customer information and configuration details is desirable to avoid unnecessarily exposing individuals to identity theft and networks from compromise, network security is important. Hence, it is desirable to establish a secure connection, or encrypted communication channel, prior to the exchange of sensitive information over an unsecured network such as Internet 104. One way to accomplish this is to establish a transport layer security (TLS) channel between two devices prior to exchanging sensitive information.

The transport layer security framework is specified according to an Internet Engineering Task Force (IETF) TLS Working Group document RFC2246 which specifies the transport layer security protocol. The transport layer refers to the middle layer of a networking framework called the open system interconnection (OSI) model and provides for transparent transfer of data between end systems or hosts. The transport layer of OSI is responsible for end-to-end error recovery and flow control to ensure complete data transfer. In establishing a traditional TLS connection, a secure connection is formed by passing encrypted information messages that are decrypted by each entity in order to mutually authenticate each entity to the other entity. Ordinary mutual authentication is typically not specific to a particular device or server, but merely verifies that each entity is in possession of a valid, encrypted certificate. Essentially, the traditional form of mutual authentication only verifies that each entity belongs to a group of approved entities, and unique information that identifies a particular CPE 124 is not used.

Once the above mutual authentication is completed, the entities traditionally proceed to set up encryption, to establish a secure connection by changing the cipher specification. This takes time which limits server availability, and can result in needlessly transferring information between the entities in the event that either entity is later deemed to be invalid due to more detailed considerations. For example, even if the traditionally authenticated CPE device is in possession of a valid, generic certificate issued by the CPE manufacturer, the CPE device may not be assigned to a valid user or listed in an approved database of valid CPE devices.

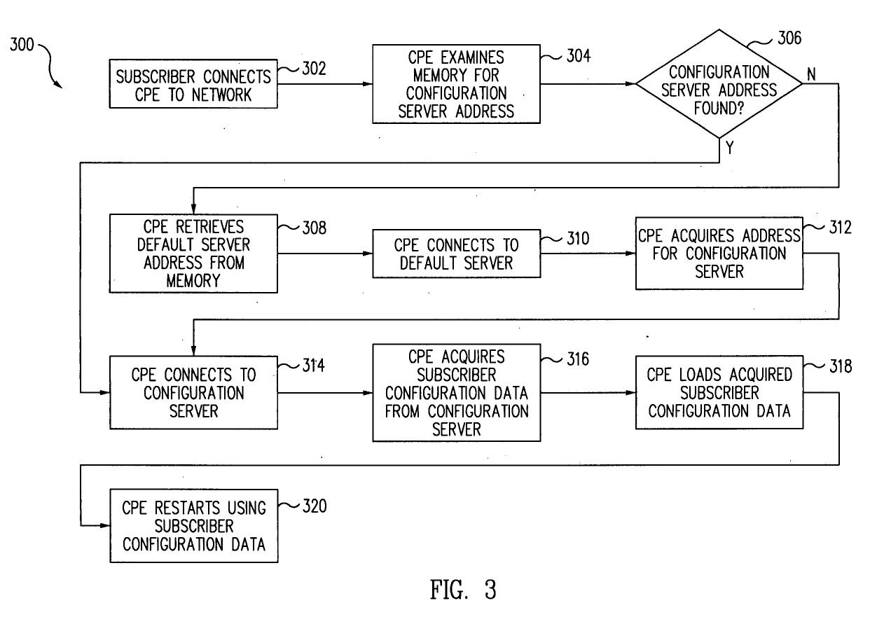

FIG. 3 shows a flow diagram describing a series of operations comprising a provisioning flow 300 where the service provider (SP) address not initially present within CPE at the start of provisioning. In reference to FIGS. 1-3, flow 300 includes a number of operations, including the subscriber connecting 302 CPE 124 to an active network. In this case, CPE 124 automatically detects the connection to an active network, and begins the configuration and provisioning process. Flow 300 continues with CPE 124 examining 304 memory unit 208 to determining 306 the presence of a valid configuration server address. If the configuration server address is not found in CPE 124, flow 300 continues with CPE 124 retrieving 308 a default server address 222 from memory unit 208.

Processing unit 206 retrieves default server address 222 and passes it to WAN communications unit 202 for connecting 310 to default server 148. In this context, connecting includes sending and receiving information between CPE 124 and default server 148 over the network. Once connected to default server 148, flow 300 continues with CPE 124 acquiring 312 a network address for configuration server 146. If CPE 124 found a configuration server address in memory unit 208 or if CPE 124 has received a configuration server address from default server 148, flow 300 continues with CPE 124 connecting 314 to configuration sever 146. Flow 300 continues with CPE 124 acquiring 316 the subscriber configuration data from configuration server 146 which is then can be stored in memory unit 208 in the location denoted as SP configuration data 224. Once the configuration data is received, flow 300 continues with CPE 124 loading 318 the acquired subscriber configuration data in order to setup the internal state of CPE 124. The internal state regarding configuration may be one of In-service (IS) or Not-in-service (NIS), where NIS refers to device that is not properly configured for voice. Finally, once CPE 124 has received and loaded the configuration data, flow 300 concludes with CPE 124 restarting 318 using the subscriber configuration data to establish service with the service provider.

In reference to FIGS. 1-3, the provisioning flow includes a transfer of information or relay of information between different servers each having insufficient information to complete the provisioning processes alone. In this manner, default server 148 may be considered as a re-direction server in order to establish service with a service provider (SP) for a generic, previously un-configured, or unassigned customer premises equipment (CPE) since the request for configuration data is redirected based on the network address information provided by default server 148 to CPE 124.

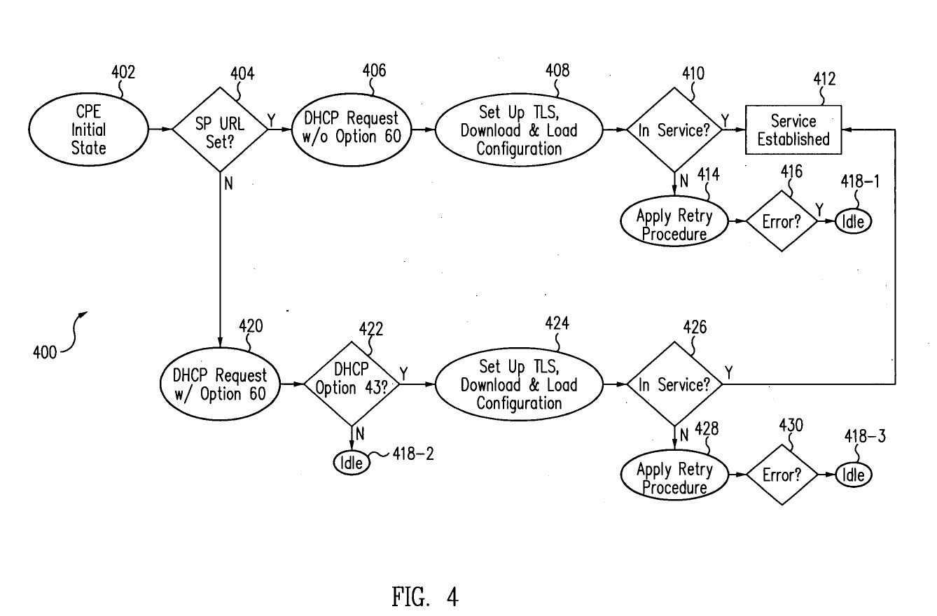

FIG. 4 shows a flow diagram describing a series of operations comprising a provisioning flow 400. Flow 400 begins with a CPE having an initial state 402 and being connected to an active network. The connection can be a wired connection where a data cable is mechanically plugged into a data port on CPE 124, or the connection may be wireless where a wireless connection is established with a wireless point-of-presence (POP) server. Once the CPE detects a connection to the active network, the CPE initiates a negotiation with a DHCP server to obtain a valid internet protocol (IP) address in a process of connecting to the packet switched network.

During this negotiation between CPE 124 and the DHCP server 140, CPE 124 broadcasts a DHCPDISCOVER message where CPE 124 asserts a MAC address to the active network in order to locate available servers. DHCP server 140 receives the DCHPDISCOVER message and responds to the broadcast by asserting a DHCPOFFER message to CPE 124 including parameters of a proposed network address. CPE 124 responds to the DHCPOFFER by sending a DHCPREQUEST message requesting the offered parameters from DHCP server 140 and implicitly declining offers from all other servers that may have responded to the DHCPDISCOVER message. There are several options available to a network device during this negotiation allowing for some vendor-specific customizations. For example, according to IETF publication RFC2132, a DHCPREQUEST may be offered with or without vendor specific information in a series of data fields identified as DHCP option-60.

If the intended service provider (SP) network address is set 404, the DHCPREQUEST will be asserted 406 without option-60. According to the IETF RFC2132, the dynamic host configuration protocol (DHCP) provides a framework for passing configuration information to hosts on a Transfer Control Protocol/Internet Protocol (TCP/IP) network. Specifically, DHCP option-60 relates to a vendor class identifier. This option is used by DHCP clients to optionally identify the vendor type and configuration of a DHCP client. Specifically, option-60 can include the vendor identifier. DHCP server 140 then responds by asserting a DHCPACK message including the committed network address to conclude the operation of connecting CPE 124 to the network as well as a network address for configuration server 146 in an option-43 vendor class field. Once the CPE network address is set, the CPE can then setup 408 a transport layer security (TLS) connection between CPE 124 and configuration sever 146 in order to acquire and initialize using the configuration data.

Once initialized, the CPE will detect whether service is established 410 with the service provider. If so, then the subscriber service is established 412 and provisioning flow 400 has terminated normally. However, if service is not established 410, then the CPE applies a retry procedure 414 in order to attempt to establish the service. This retry procedure 414 should allow the CPE to become properly registered when the network connectivity issue is resolved, not related to wrong configuration parameters or hardware/firmware problems. If the retry procedure 414 is not successful, an error condition 416 is assumed and the CPE enters an idle state 418-1. In an idle state (418-1, -2, and -3), CPE 124 will remain inactive until an external intervention such as a reset, or a manually initiated reconfiguration. The service status can be reflected by an indicator such as the status of a ready light, an icon or graphical symbol on a display, or some other indication to convey the status of the CPE to a user. Alternatively, a service availability indication may be asserted to another device on the LAN of first cluster 102 including an indicator on the first service terminal 122.

If after CPE 124 is connected to the active network it detects that the SP network address is not set 404, the DHCPREQUEST will be asserted 420 with option-60, an optional field for carrying vendor specific information where the definition of this information is vendor specific. DHCP server 140 detects 422 receipt of a DHCPREQUEST having option-60, and if configured with vendor defined network address, responds by asserting a DHCPACK message with option-43 to provide committed network address for configuration server 146 to conclude the operation of connecting CPE 124 to the network. DHCP option-60 is used by the client to identify the vendor. If the DHCP server is set up (provisioned) to respond with vendor specific information, the DHCP server includes information in its response in DHCP option-43 to the DHCP client. In this case, the specific information is a VSP URL. Since many DHCP servers may reply to a DHCPDISCOVER message, the CPE where the SP network address is initially not set would only consider a DHCPREQUEST to those DHCP servers that were capable of responding with a configuration server network address.

Prior to this invention, if a DHCPREQUEST was asserted with option-60, DHCP server 140 would not respond with a configuration server network address if it is not configured with SP defined configuration server address, the CPE would enter the idle state 418-2 since there would be no way to reconcile the DHCPREQUEST option-60 data with a configuration server address if the vendor information, DHCP option-43, was not known. Alternatively, if no DHCP server responded appropriately to the DHCPREQUEST bearing option-60, then CPE would enter idle state 418-2. Once the network address for configuration server 146 is received, CPE 124 can then setup 424 a transport layer security (TLS) connection between CPE 124 and configuration sever 146 in order to acquire and initialize CPE 124 using the configuration data. Once initialized, CPE 124 will detect whether service is established 426 with the service provider. If so, then the subscriber service is established 412 and provisioning flow 400 has terminated normally. However, if service is not established 426, then the CPE applies a retry procedure 428 in order to attempt to establish the service. If the retry procedure 428 is not successful, an error condition 430 is assumed and the CPE enters an idle state 418-3.

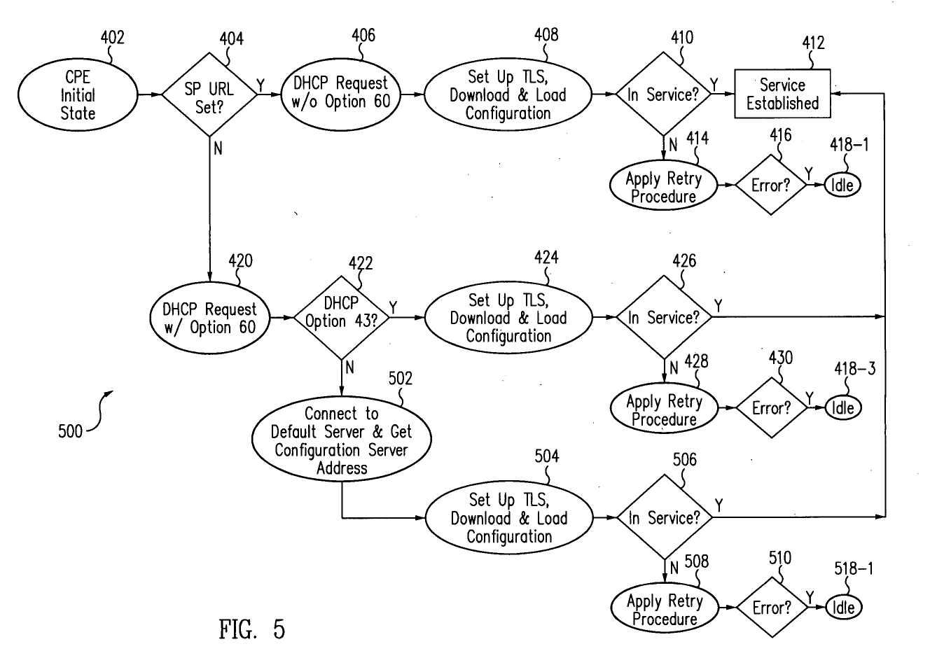

FIG. 5 shows a flow diagram describing a series of operations comprising a provisioning flow 500. Flow 500 includes all of flow 400 as shown in FIG. 4 and includes an innovation to resolve the problem when a CPE client does not assert a DHCPREQUEST with option-60, or if an appropriate server response with option-43 to the DHCPREQUEST with option-60 is not received in a timely manner, then CPE 124 can connect 502 to default server 148 in order to get the network address for configuration server 146. Once the network address for configuration server 146 is received, CPE 124 can then setup 504 a TLS connection between CPE 124 and configuration sever 146 in order to acquire and initialize CPE 124 using the configuration data. Once initialized, CPE 124 will detect whether service is established 506 with the service provider. If so, then the subscriber service is established 412 and provisioning flow 500 has terminated normally. However, if service is not established 506, then CPE 124 applies a retry procedure 508 in order to attempt to establish the service. If the retry procedure 508 is not successful, an error condition 510 is assumed and the CPE enters an idle state 518-1. As discussed above, in idle state 518-1, CPE 124 will remain un-configured for the service provider until an external intervention such as a reset, or a manually reconfiguration is initiated.

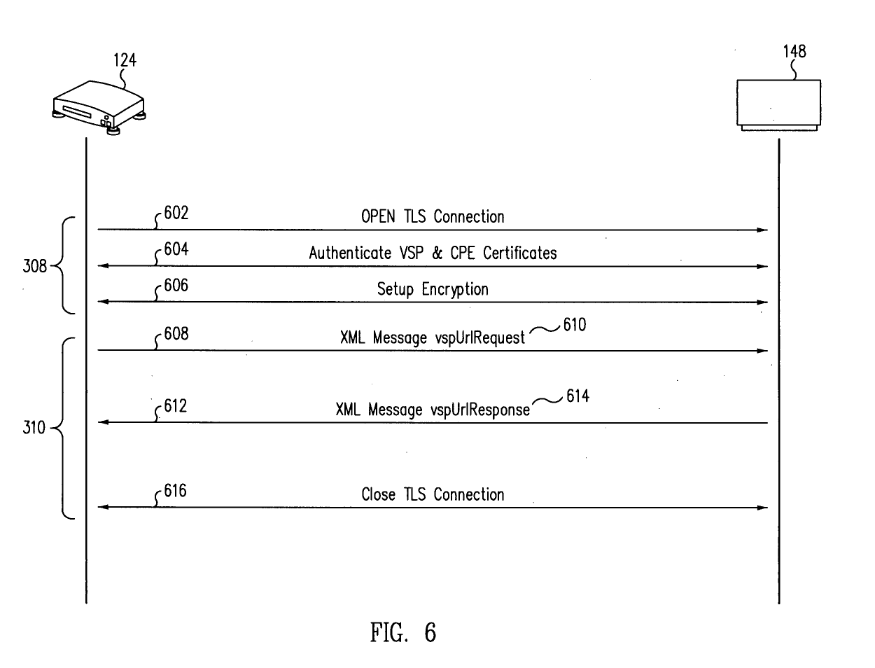

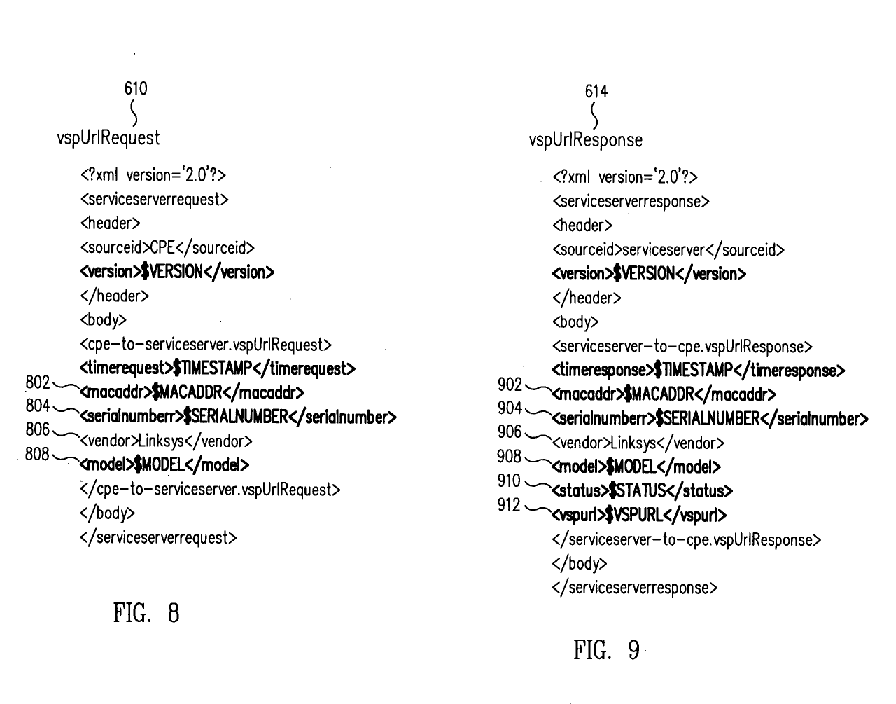

FIG. 6 shows a high-level flow diagram describing exemplary interactions between CPE 124 and default server 148. Operation 310, where CPE 124 connects to default server 148, includes opening 602 a TLS connection, mutually authenticating 604 both SP and CPE certificates, and setting up encryption 606 using the change cipher specification which establishes the secure connection between CPE 124 and default server 148. Operation 310, where CPE acquires the network address of configuration sever 146, includes CPE 124 sending 608 a service request message 610, receiving 612 a service response message 614 including network address information for configuration server 146, and closing 616 the TLS connection. Service request message 610, as shown in FIG. 8, includes unique identifying information for CPE 124 including a MAC address and serial number. Default server 148 uses the identifying information in message 610 to examine one or more databases in order to determine if CPE 124 is allocated to a particular SP. If default server 148 finds CPE 124 is allocated with a particular SP, default server 148 will reply in message 610 with the network address of the appropriate configuration server 146. Service response message 614, as shown in FIG. 9, includes a network address for the configuration server 146.

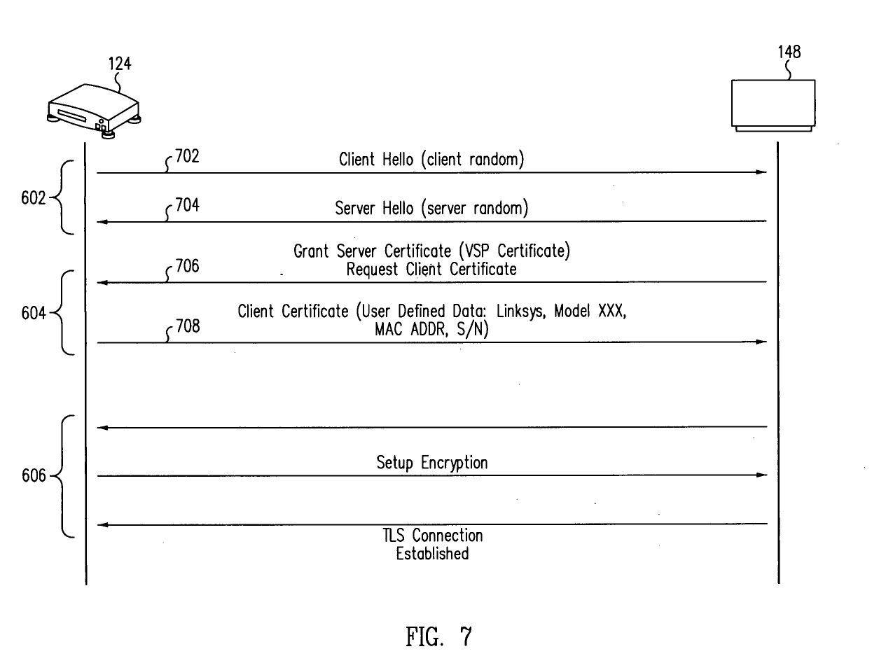

FIG. 7 shows an exemplary transaction diagram for a portion of the procedure to establishing a transport layer security (TLS) connection between CPE 124 and default server 148, for example, prior to exchanging sensitive customer and address information data. CPE 124 initiates the TLS process by sending 702 a client hello message to default server 148, which answers 704 client hello message 702 with a corresponding server hello message, corresponding to opening 602 a TLS connection. CPE 124 stores a CPE private key and a default server public key. Conversely, default server 148 stores a CPE public key and a default server private key.

Following the sending 704 of server hello message, default server 148 sends 706 a grant VSP server certificate message granting the initialization server VSP certificate and requesting the CPE 124 client certificate. The VSP certificate is already encrypted using the default server 148 private key. CPE 124 decrypts the VSP server certificate with the initialization server public key and checks the identity of the organization that issued the VSP certificate. If the VSP certificate issuer is not approved, the TLS procedure is abandoned.

The VSP certificate issuer may not be approved if the issuer is not an approved vendor or if an authentication problem prevents the authentication process from completing normally. However, if the VSP certificate issuer is approved, CPE 124 sends the encrypted CPE certificate and user defined data using the CPE private key and sends the encrypted CPE certificate along with user defined data in a client certificate message 708. At this point, default server 148 authenticates the CPE certificate by decrypting it using the CPE public key and verifying the issuer is approved.

If the issuer is not approved, the TLS procedure is abandoned. However, if the issuer is approved, default server 148 proceeds to matching the decrypted CPE data with the CPE data records previously stored in a CPE database. If there is a match found in the CPE database, default server 148 determines if the particular service provider (SP) service has been approved for this CPE unit. If SP service has not been approved, the TLS procedure is abandoned. However, if the SP service has been approved, the TLS procedure continues to set up the session encryption using a change cipher specification protocol. Message 706 and message 708 correspond to mutually authenticating 604 both SP and CPE certificates. Once the cipher specification is changed, corresponding to setting up encryption 606, the TLS connection is established providing security for the exchange of information with default server 148.

FIG. 8 shows an exemplary service request message 610 from a CPE manufactured by LINKSYS. Message 610 can be communicated in a variety of formats. In one embodiment, message 610 is expressed as an extensible markup language (XML) format where various fields or elements are tagged using meta-tags. The fields within message 610 are either static or dynamic. A static field does not change, while a dynamic field will change based on various conditions. A macaddr field 802 is dynamic and will depend on the assigned MAC address associated with CPE 124 during manufacture. Similarly, a serialnumber field 804 is dynamic and corresponds to the manufacturer serial number associated with CPE 124 during manufacture. A vendor field 806 is static and describes the name of the manufacturer in a text-readable format. Finally, a model field 808 is a dynamic field that can depend on both the static base hardware configuration as well as the dynamic firmware version currently present within CPE 124.

FIG. 9 shows an exemplary service response message 614 to a CPE manufactured by LINKSYS. Similar to message 610, the fields within message 614 are either static or dynamic. A macaddr field 902 is dynamic and will depend on the assigned MAC address associated with default server 148 during manufacture. Similarly, a serialnumber field 904 is dynamic and corresponds to the manufacturer serial number associated with default server 148 during manufacture. A vendor field 906 is static and describes the name of the manufacturer in a text-readable format. Finally, a model field 908 is a dynamic field that can depend on both the static base hardware configuration as well as the dynamic firmware version currently present within default server 148. A status field 910 is a dynamic field that denotes whether or not CPE 124 was found in any of the searched databases. A vspurl field 912 is a dynamic field that contains the network address of the appropriate configuration server 146. If default server 148 finds CPE 124, status field 910 reflects a status of “Available” and vspurl field 912 contains a URL for configuration server 146. Conversely, if default server 148 does not find CPE 124, status field 910 reflects a status of “Not Available” and vspurl field 912 is set to “NULL”.

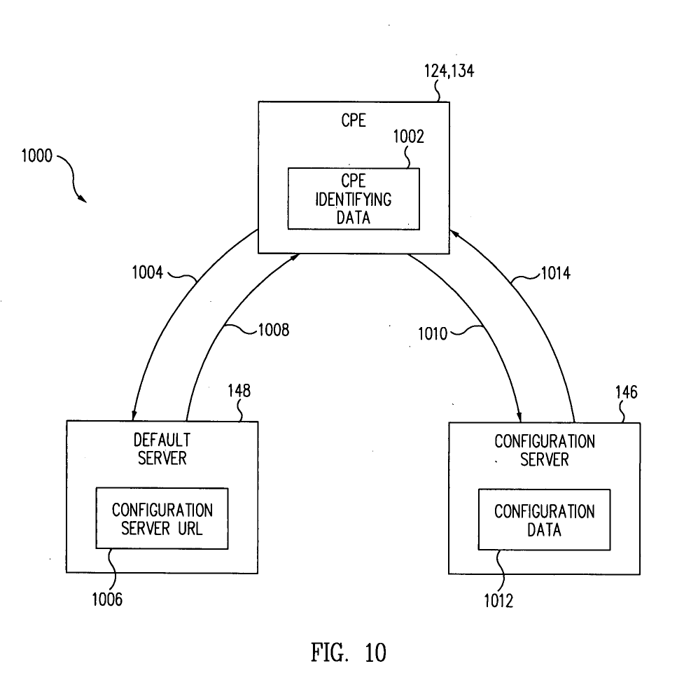

FIG. 10 shows a block diagram illustrating a configuration message flow 1000 between a CPE 124, a default server 148, and a configuration server 146, in accordance with an embodiment of the invention. CPE 124 includes unique, identifying data 1002 including a serial number, a MAC address, and user account information. CPE 124 sends a configuration server network address request message 1004 to default server 148 requesting a configuration server network address 1006 for configuration server 146. The configuration server network address request message 1004 includes at least a portion of CPE identifying data 1002. Default server 148 extracts the CPE identifying data 1002 from the request message 1004 in order to search a database for the address of a configuration server corresponding to the CPE 124. Default server 148 may retain the configuration server network address 1006 in a local database or may have access to one or more remote databases containing the appropriate information. Default server 148 retrieves the stored network address 1006 from the appropriate database and responds to CPE 124 with a configuration server network address response message 1008 including configuration server network address 1006 for the appropriate configuration server 146.

Once CPE 124 receives the configuration server network address response message 1008, CPE 124 extracts the configuration server network address 1006 and sends a configuration data request message 1010 to configuration server 146 at the configuration server network address 1006. The configuration data request message 1010 includes a predetermined portion of the CPE identifying data 1002 so that configuration server 146 may locate the appropriate configuration data 1012 for CPE 124. Similar to default server 148, configuration server 146 may retain the configuration data 1012 in a local database or may have access to one or more remote databases containing the appropriate information. Configuration server 146 retrieves the stored configuration data 1012 from the appropriate database and responds to CPE 124 with a configuration data response message 1014 including configuration data 1012 for the appropriate configuration server 146. As described, CPE 124 distributes appropriate portions of configuration data 1012 and initializes CPE 124 to establish service with a service provider. To protect sensitive information, all message content may be encrypted or sent through a transport layer security

Although the invention has been described with respect to particular embodiments, this description is only an example of the invention's application and should not be taken as a limitation. Consequently, the scope of the invention is set forth in the following claims.

We claim:

1. A customer premises equipment (CPE) apparatus, comprising:
a memory unit adapted to store and retrieve a plurality of network addresses including a default server network address corresponding to a default server;
a communications unit adapted to send messages to and receive messages from a plurality of servers over a communications network, each server being specified by a unique network address; and
a processing unit adapted to determine if a configuration server network address is present within the memory unit, the processing unit being adapted to retrieve the default server network address from the memory unit and send a configuration server network address request message through the communications unit to the default server when the configuration server network address is not present within the CPE.

2. The CPE apparatus of claim 1,
wherein the CPE is adapted to receive a configuration server network address response message through the communications unit, the communications unit being adapted to receive a configuration information message from a configuration server, and
wherein the processing unit is adapted to extract the configuration server network address from the configuration server network address response message, the processing unit being adapted to send a configuration data request message to a configuration server at the configuration server network address.

3. The CPE apparatus of claim 2, wherein the processing unit is adapted initialize the CPE using the configuration information to establish service with a service provider.

4. The CPE apparatus of claim 3, wherein the service provider is a voice service provider (VSP).

5. The CPE apparatus of claim 1, wherein the processing unit examines the memory unit for the presence of the configuration server network address automatically after connection of the CPE to an active network.

6. The CPE apparatus of claim 5, wherein the processing unit retrieves the default server address automatically after determining the configuration server address is not present within the CPE.

7. The CPE apparatus of claim 1, wherein the communications unit sends and receives messages conforming to the Internet Protocol (IP).

8. The CPE apparatus of claim 7, wherein each network address is expressed as a uniform resource locator (URL).

9. A method of establishing service between customer premises equipment (CPE) and a service provider (SP), comprising:
determining the absence of a first network address within the CPE, the first network address being associated with a first server;
accessing a second server at a second network address that is present within the CPE, the second server providing the first network address;
accessing the first server at the first network address provided by the second server, the first server providing configuration data; and
initializing the CPE with the configuration data to establish service with a SP.

10. The method of claim 9, wherein the SP is a voice service provider (VSP).

11. The method of claim 9, wherein the first network address specifies a configuration server associated with a service provider.

12. The method of claim 9, wherein the second network address specifies a default server.

13. The method of claim 9, wherein each network address is expressed as a uniform resource locator (URL).

14. The method of claim 9, wherein the operation of determining the absence of a first network address within the CPE further comprises:
examining a memory unit within the CPE to confirm the first network address is not present.

15. The method of claim 9, wherein the operation of accessing a second server at a second network address that is present within the CPE unit further comprises:
sending a network message to the second server containing identifying information; and
receiving a network message from the second server containing the first network address.

16. The method of claim 9, wherein the second network address is for a default server, the default server providing the first network address of the first server.

17. The method of claim 9, wherein the operation of accessing the first server at the first network address received from the second server further comprises:
sending a network message to the first server; and
receiving a network message from the first server containing CPE configuration information.

18. The method of claim 9, wherein the operation of initializing the CPE unit with the configuration information further comprises:
distributing the received configuration information to predetermined locations within the CPE; and
setting internal states within the CPE to facilitate communication according to the service provided by the service provider.

19. The method of claim 9, further comprising:
connecting the CPE to a communications network;
detecting the communications network is active;
executing an operation within the CPE to retrieve a stored network address for the default server; and
opening a secure connection with the default server.

20. The method of claim 19, wherein opening a secure connection further comprises:
exchanging security certificates including encrypted information between the CPE and the default server, the CPE security certificate including CPE specific information to allow the default server to verify whether the CPE is valid, the default server security certificate including default server specific information to allow the CPE to verify whether the default server is valid; and
mutually authenticating the validity of the exchanged security certificates,
wherein the secure connection with the initialization server is closed if one of the CPE unit and the default server fail in mutual authentication.

21. A network device, comprising:
a memory means for storing a default server address and identifying data associated with the network device;
an examining means for examining the memory to determine the absence of a configuration server address;
a request message sending means for sending a configuration server address request message to the default server at the default server address when the configuration server address is absent from the memory.

22. The network device of claim 21, further comprising:
a response message receiving means for receiving a default server response message including a configuration server address.

23. The network device of claim 22, further comprising:
a request message sending means for sending a configuration data request message to the configuration server; and
a response message receiving means for receiving a configuration data response message including configuration data for the network device.
